(19) United States
(12) Patent Application Publication
(10) Pub. No.: US 2002/0174176 A1
(43) Pub. Date: Nov. 21, 2002

(54) Method and apparatus for viewing and interacting with category specific information

(76) Inventors: Albert G. Pinto, Anaheim Hills, CA (US); Malachi D. Clark, Costa Mesa, CA (US)

Correspondence Address: STETINA BRUNDA GARRED & BRUCKER, 75 ENTERPRISE, SUITE 250, ALISO VIEJO, CA, 92656, US

(21) Appl. No.: 09/840,350

(22) Filed: Apr. 23, 2001

(51) Int. Cl. G06F 15/16

(52) U.S. Cl. 709/203; 707/104.1; 709/219; 709/205

(57) ABSTRACT

A system and method for displaying category specific information is disclosed. The system includes a category specific browser that establishes a dedicated connection between the client computer hosting the category specific browser and a server containing the category specific information. The dedicated connection between the client computer and the server computer prevents the category specific browser from receiving data from any source other than the server. A plurality of client computers each having a respective dedicated connection to the server computer form a targeted community wherein each client computer is a member of the targeted community.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to browsers, and more particularly, to a method and system for implementing a category specific mini browser used for displaying and interacting with specific content.

A browser is an application program that provides a way to view and interact with information available on the World Wide Web. The first Web browser with a graphical user interface was NCSA Mosaic™ which was invented in 1992. Netscape Navigator® and Microsoft® Internet Explorer™ have since been introduced and are the two Web browsers dominating the market today. A Web browser is a client program that uses HyperText Transfer Protocol (HTTP) to request Web pages from Web servers throughout the Internet.

Browsers allow users to potentially access any information available on the Internet. Due to the voluminous amount of information on the Internet, users often must sift through large amounts of unwanted data in order to find the information of interest.

Thus, a need exists for a browser that allows a user to view and interact only with information in a specific area of interest.

### BRIEF SUMMARY OF THE INVENTION

The present invention provides a method for viewing and interacting with category specific data in a category specific browser. The method comprises: generating a category specific browser user interface; displaying the category specific browser user interface on a client computer; establishing a dedicated connection between the client computer and a server computer, the server computer comprising a category specific database that stores the category specific data, the dedicated connection between the client computer and the server computer preventing the category specific browser from receiving data from any source other than the server, a plurality of client computers each having a respective dedicated connection to the server computer forming a targeted community wherein each client computer is a member of the targeted community and members of the targeted community all have access to the same category specific data; in response to a user request at the client computer: formatting a database query to retrieve selected category specific data from the category specific database; transmitting the database query to the server via the dedicated connection to the server; receiving the selected category specific data via the dedicated connection to the server; and displaying the selected category specific data in the category specific browser user interface.

In accordance with other aspects of the invention, transmissions over the dedicated connection between the client computer and the specified server computer are encrypted.

In accordance with still other aspects of the invention, in response to a user request, a chat mode is initiated with one or more other members of the targeted community, the client computer and the one or more other members of the targeted community each simultaneously having a respective dedicated connection to the server, the chat mode excluding clients that do not have a dedicated connection to the server; and while in the chat mode: forwarding user input received via a user input device to the server for transmission to the one or more other members of the targeted community; and receiving data from one or more other members of the targeted community via the server and displaying the received data in the category specific browser user interface.

In accordance with yet other aspects of the invention, the category specific database comprises data for a plurality of categories. The category specific browser can display data from multiple categories.

In accordance with further aspects of the invention, the category specific data may be electronic trading cards. The electronic trading cards may relate to personalities. The personalities may be sports personalities.

In accordance with still further aspects of the invention, the category specific data may be corporate data comprising information about a specific business entity.

In accordance with yet further aspects of the invention, the category specific data may be video data and/or audio data.

In accordance with still other aspects of the invention, generating the category specific browser user interface comprises: providing a generic category specific browser user interface having a first appearance; and in response to a user configuration command, modifying the generic category specific browser user interface to have a second appearance as defined by the user configuration command. For example, the second appearance may comprise a different logo than the first appearance and/or the second appearance may comprise a different set of user controls than the first appearance.

In accordance with still other aspects of the invention, news may be displayed in the category specific browser in addition to the category specific data.

In accordance with other aspects of the invention, a system for viewing and interacting with category specific data is disclosed. The system comprises: a category specific browser that displays category specific data; and an external interface in communication with the category specific browser, the external interface forwarding data received from a server to the category specific browser and transmitting data received from the category specific browser to the server, the external interface establishing an exclusive connection to the server that prevents the category specific browser from receiving data from a source other than the server.

### BRIEF DESCRIPTION OF THE DRAWINGS

These as well as other features of the present invention will become more apparent upon reference to the drawings wherein:

FIG. 1 is a block diagram illustrating exemplary components for a category specific browser formed in accordance with the present invention;

FIG. 2 is a block diagram illustrating components of the ETC user shown in FIG. 1;

FIG. 3 is a block diagram illustrating components of the Electronic Trading Card (ETC) server shown in FIG. 1;

FIG. 4 is a flow diagram illustrating exemplary logic performed by a category specific browser formed in accordance with the present invention; and

FIGS. 5A-5J illustrate an exemplary user interface for a mini browser displayed at an ETC user of FIG. 1.

### DETAILED DESCRIPTION OF THE INVENTION

The present invention is directed to a category specific browser, also referred to herein as a mini browser or a captive vertical portal (CVP). In exemplary embodiments, the mini browser is database driven and pulls information from a central database via a server. Preferably, the information in the database is encrypted and can only be played in the appropriate mini browser. Preferably, the mini browser can be configured to represent anything in terms of physical appearance on the user's desktop. For example, a company can have its logo displayed in the browser and data in the database for their system coded directly into the browser. The category specific mini browser provides information received from a single server to a user. This “dedicated” connection between the client computer (user) and the server computer ensures that the user only receives the category specific information. The mini browser application receives triggers that cause it to check for new information. For example, a trigger may be received when new information is available or when a specified period of time has elapsed since the last check for new information. When new information is available, it is pulled into the mini browser.

The mini browser allows for the formation of a community. Preferably, the mini browser has a built-in chat feature that allows end users to communicate with each other through the system. The chat feature is similar to America Online® (AOL) Instant Messaging™ or Microsoft® Messenger™. Thus, users can communicate with each other through the system. A corporate user can talk to individuals, groups or the entire community.

In exemplary embodiments of the invention, user interactions are stored in a master database that can be used to target consumers or other members of the community. Interactions (e.g., every use and every click) can be recorded and used to distribute targeted advertisements and information. For example, a financial community, can be created and used to share information such as stock tickers, updates and news and information on particular stocks. The owners of a certain stock can have streaming information for the particular stock. The users of the CVP can discuss their transactions, other stock information, etc. The company can send targeted information to each end user in order to maximize the potential for e-commerce. This makes the advertisements more effective which enables them to generate a higher cost per thousand (CPM) rate on advertising due to the targeted nature of the advertisements.

In exemplary embodiments, the information for the mini browsers is stored in a single database with markers separating information based on parts, categories and/or clients, etc. For example, several corporate clients may each have a mini browser with their logo, clients, specials, news, etc. The information pertaining to each corporate client can be updated by a user with proper access, for example, a user identification and password. If at some point two corporate clients want to do some cross promotions, only minor changes are required to enable the two sets of users to have access to a portion of each other's data.

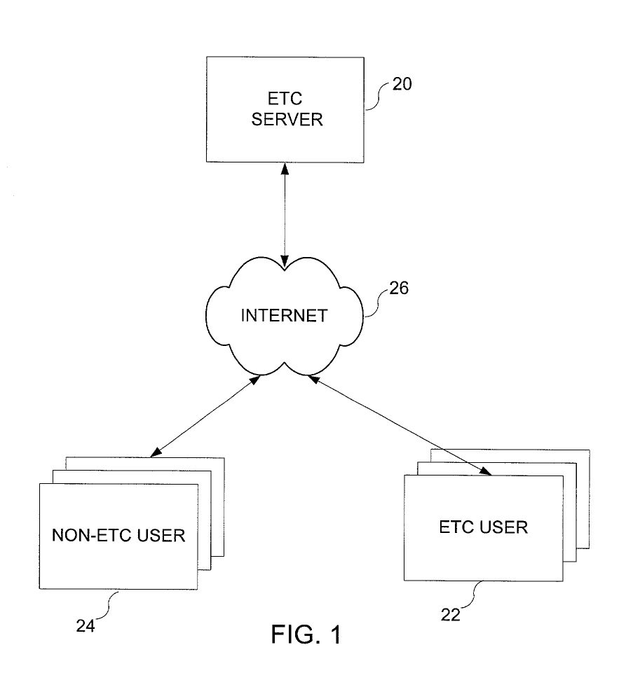

FIG. 1 is a block diagram illustrating components for implementing an exemplary category specific browser formed in accordance with the present invention. The example used herein is directed to an electronic trading card (ETC) system. It will be appreciated that the ETC system is but one embodiment for using the category specific mini browser of the present invention. The category specific browser of the present invention can be used to display information to virtually any community of users. Examples include, but are not limited to, individuals within an organization (e.g., a corporation), individuals in a club, individuals with a common interest (e.g., sports, television, music), or individuals seeking to meet other individuals (e.g., a personal ads community).

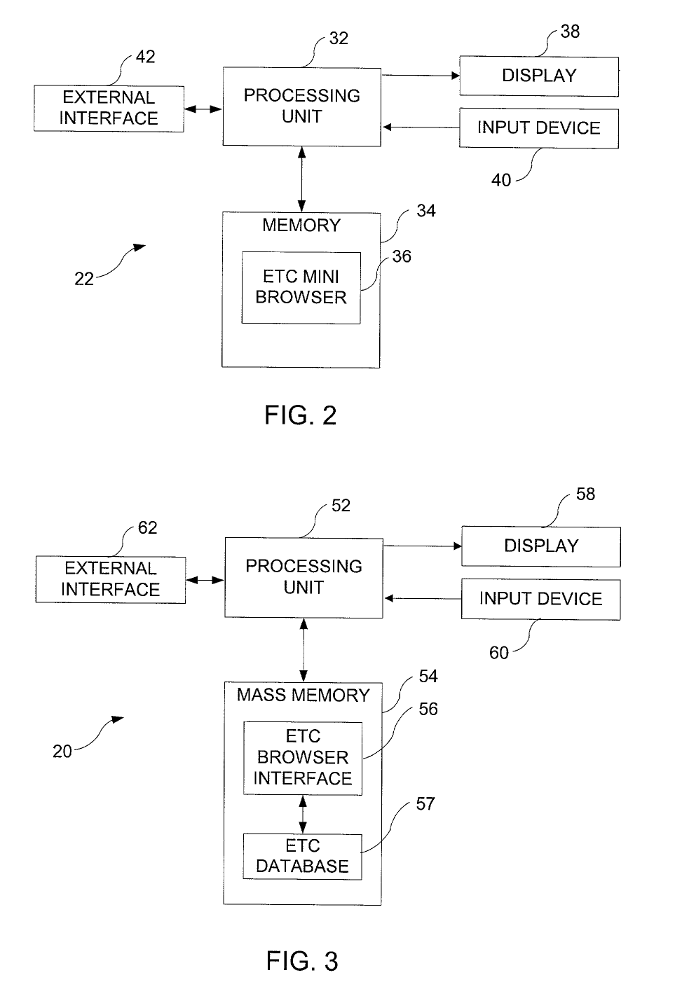

As shown in FIG. 1, a plurality of users of the category specific browser (e.g., ETC users) 22 can display information in a category specific browser. An exemplary ETC user 22 is shown in further detail in FIG. 2 and described next.

In exemplary embodiments, the category specific browser can be implemented on various computing platforms, for example, a personal computer (PC) (e.g., running a Windows™ based operating system, an Apple® operating system, Linux™, etc.), a personal digital assistant (PDA), a mobile telephone, etc. The user's computer 22 includes a processing unit 32 and a memory 34. A mini browser program 36 (i.e., executable code) is run on the user's computer 22 and is described in further detail below. The user's computer 22 includes a display device 38 for displaying the category specific data. An input device 40 is provided for the user to interact with the category specific data. An external interface 42 allows for communications between the user's computer 22 and the server 20. With the exception of the mini browser software 36, the various components of the user's computer 22 are known in the art and are not described in further detail herein. It will be appreciated that various other components (e.g., speakers, printer, etc) may be included in the user's computing device 22.

The category specific information displayed on the user's computer 22 is retrieved from a server (e.g., an ETC server) 20 over a network 26, e.g., the Internet. FIG. 3 illustrates various components of a server 20 formed in accordance with the present invention. The server 20 can be any one of various types of computers, e.g., a personal computer running Windows™ NT™. As with the user's computer 22, the server computer 20 includes known computing device components, such as a processing unit 52, a memory 54, a display 58, an input device 60 and an external interface 62. The server 20 includes a browser interface 56 that receives requests (e.g., database queries) from the mini browser 36. The browser interface 56 retrieves data from the appropriate database 57 and transmits the data to the mini browser. It will be appreciated that the server 20 may contain several databases that support a variety of category specific browsers 36. It will also be appreciated that the server may contain a single database 57 configured (e.g., with markers) to support a variety of category specific mini browsers 36. A user may have multiple category specific mini browsers 36 that are connected to different servers 20.

In exemplary embodiments, category specific browser users 22 can send information to users without a category specific browser 24. For example, an ETC user 22 can send an e-mail message to a non-ETC user 24. The email may contain a portion of an ETC trading card and a link that allows the non-ETC user to navigate to a site where software can be downloaded so that the non-ETC user 24 can download the mini browser software and become an ETC user 22.

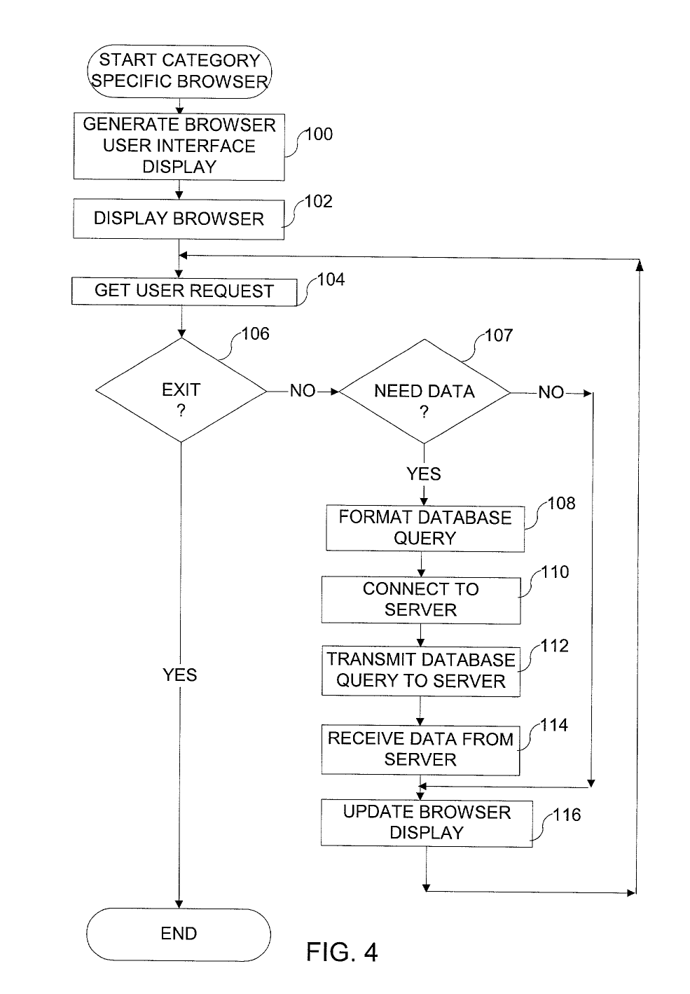

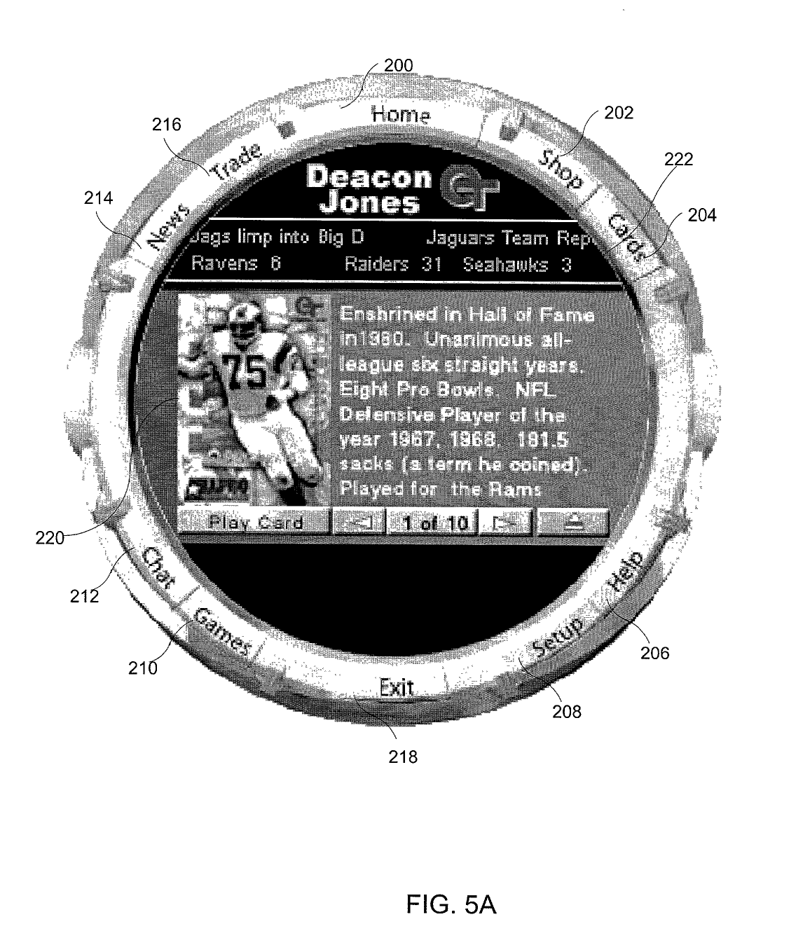

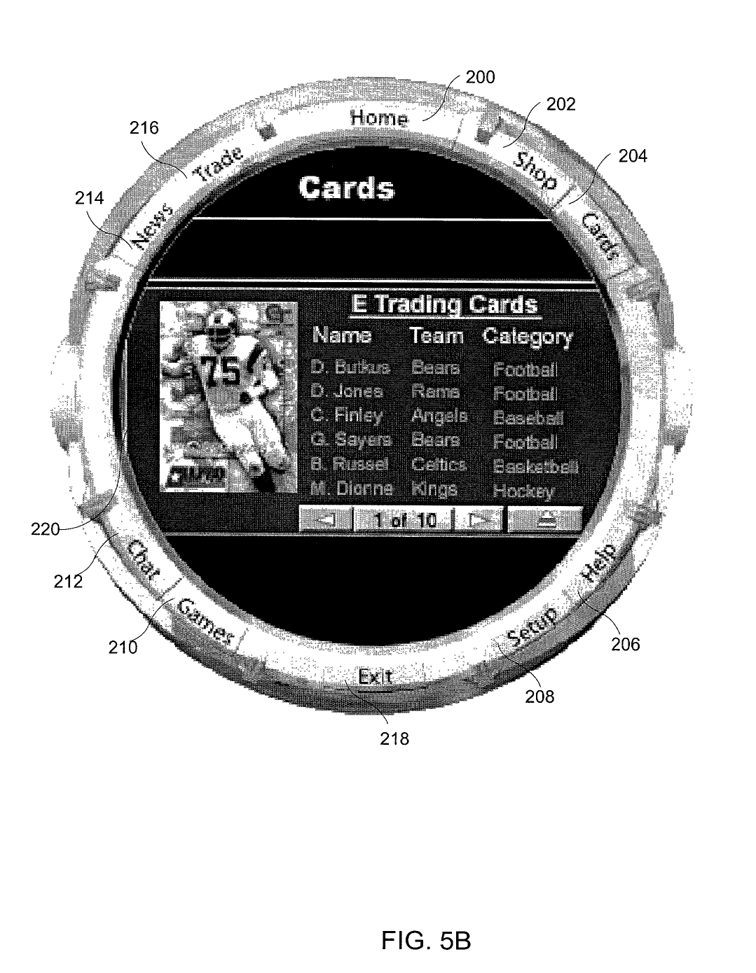

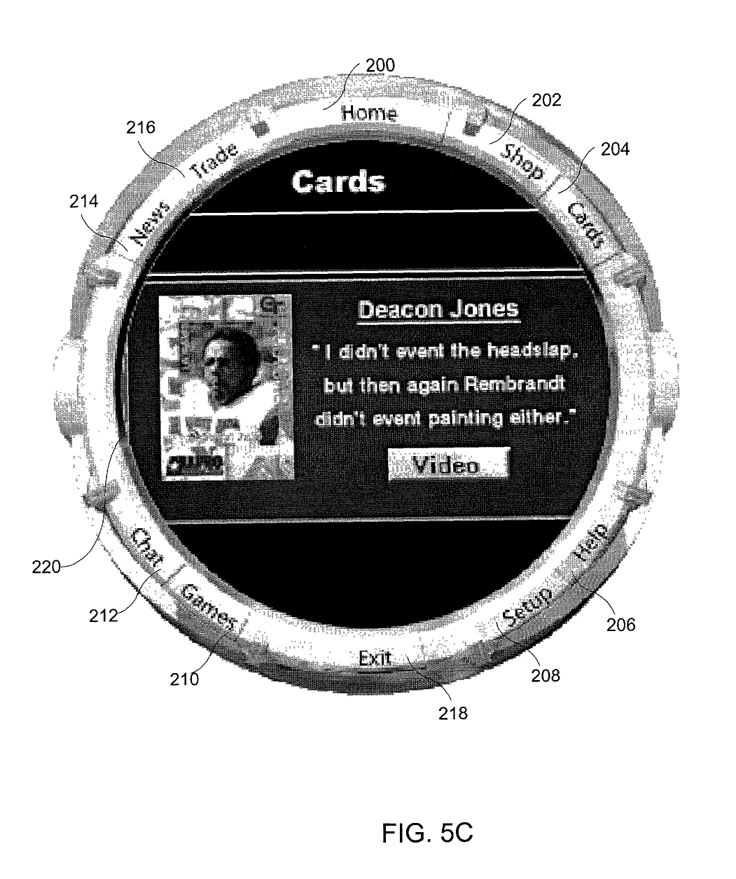

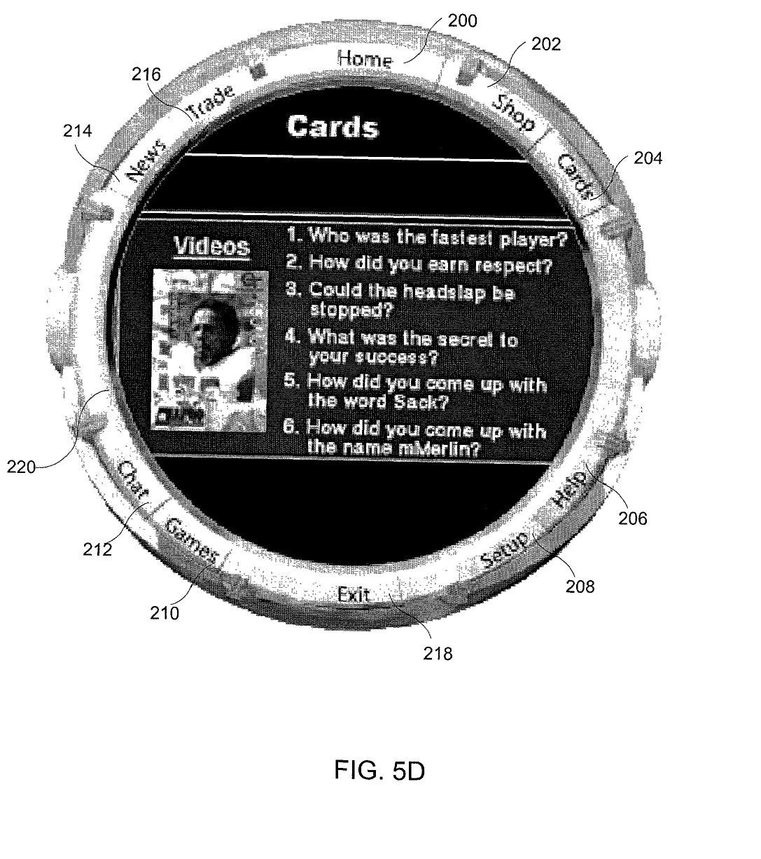

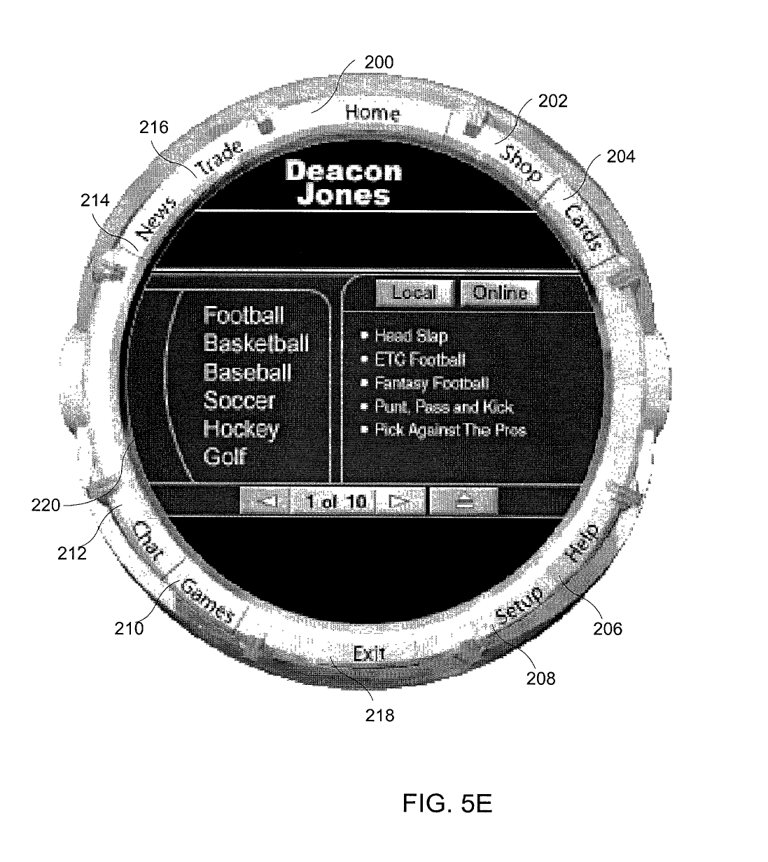

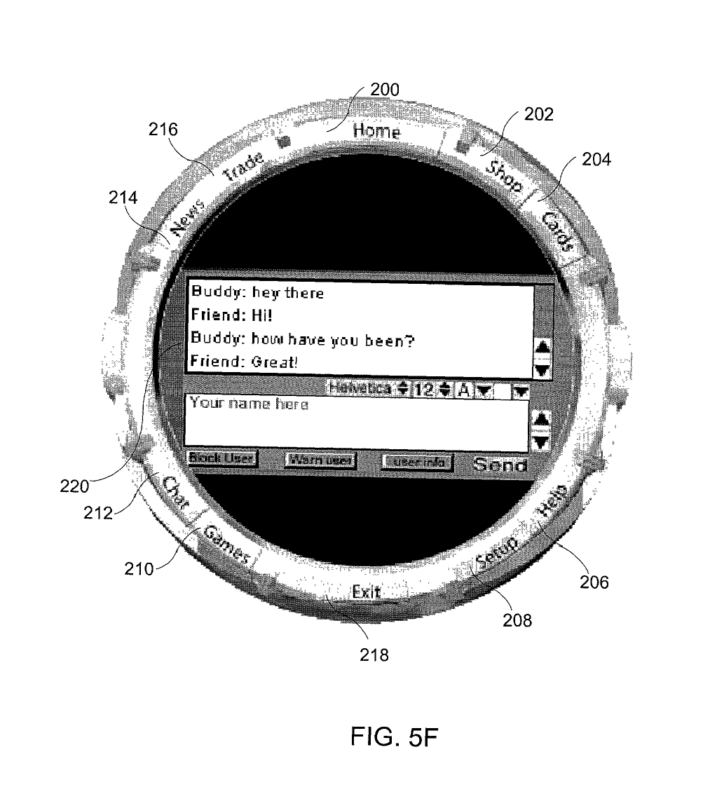

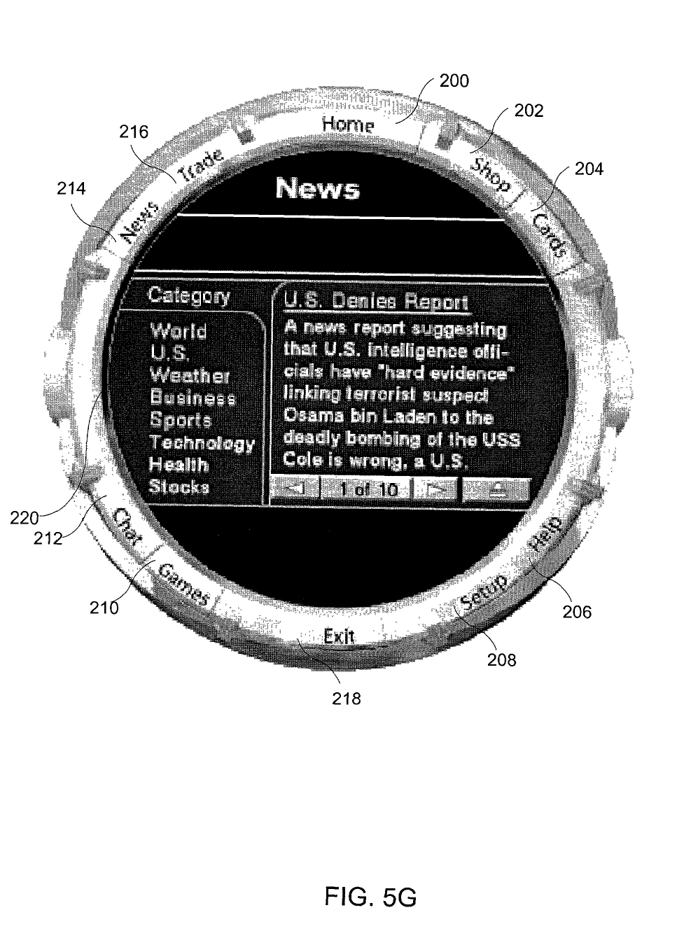

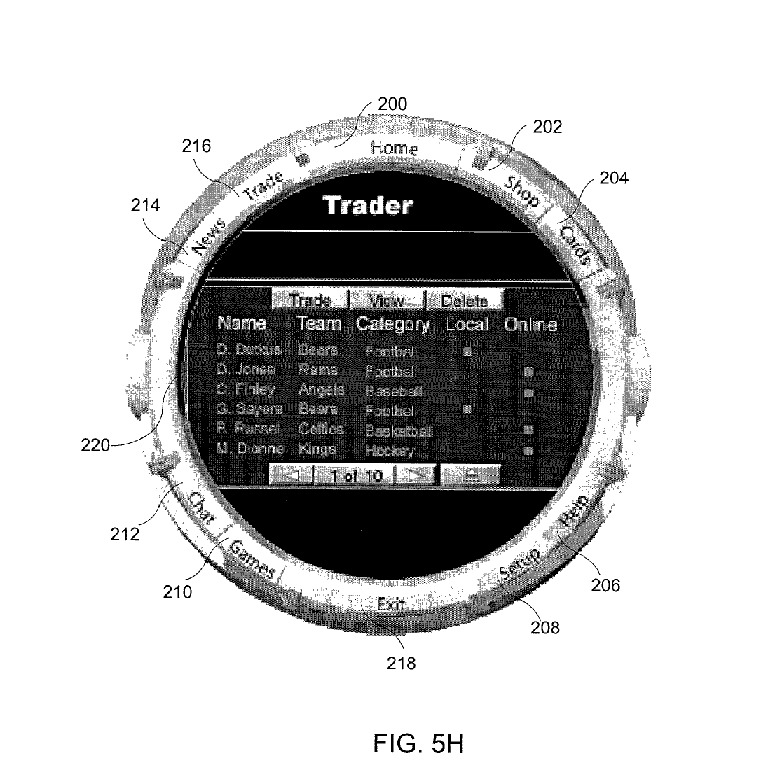

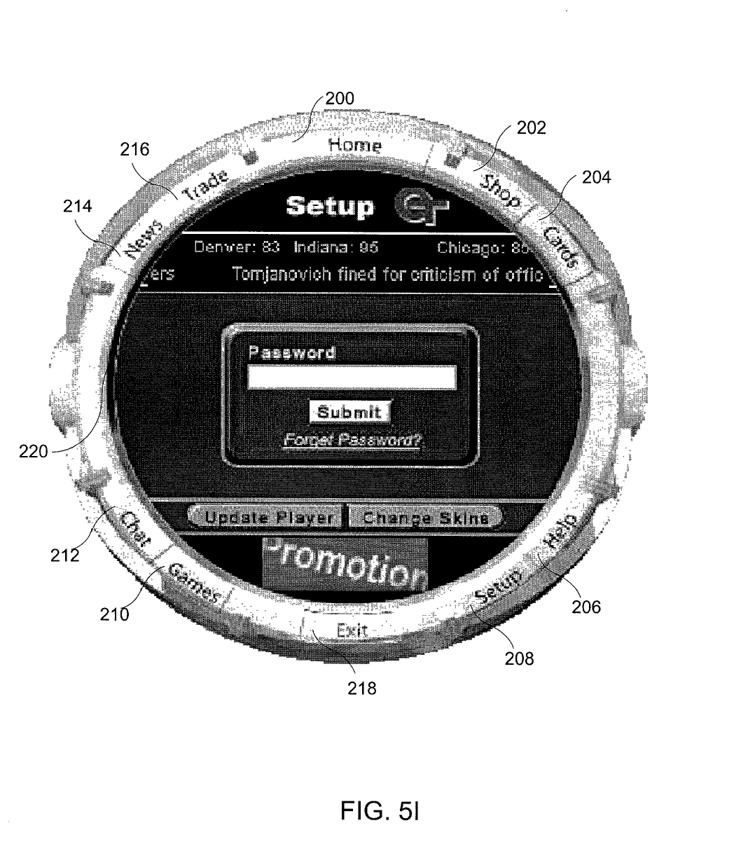

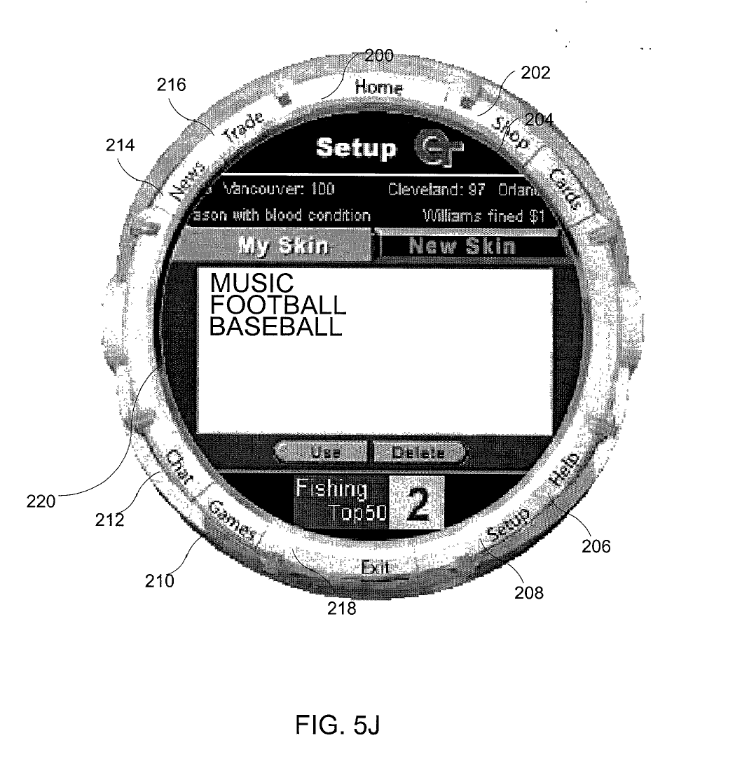

FIG. 4 is a flow diagram illustrating exemplary logic for implementing a category specific mini browser 36 formed in accordance with the present invention. Preferably, the logic shown in FIG. 4 is implemented on the user's computer 22. The mini browser logic shown in FIG. 4 can be invoked directly by a user performing an action, such as running the mini browser program. Alternatively, the browser may indirectly be invoked, for example by selecting a link on a website or in an e-mail message to view a trading card. Upon invocation, a browser user interface display is generated (step 100). In exemplary embodiments, there is a default (e.g., a generic) user interface display having a given appearance. Preferably, the user can modify the default user interface. For example, the user may define one or more logos to be displayed in the browser. The user may also define controls, e.g., buttons used to initiate various functions. For example, a user may have a mini browser that is used to display information from multiple categories, for example sports information and corporate information. A different “skin” is defined for each category. The user selects a category or “skin.” The category specific information for the selected skin is displayed. If the user wishes to view information for another category, the user switches to the appropriate skin for the desired category. Generating the user display typically requires connection to the server 20 to obtain data for display in the user interface. Next, the user interface for category specific browser is displayed (step 102). For example, a home display screen for the user interface is displayed. FIGS. 5A-5J illustrate an exemplary user interface described later.

After the user interface is displayed, user inputs are received and processed. Upon receipt of user input (step 104), a determination must be made as to how to process the user input. If the user input is an exit request (e.g., the user presses an exit button), decision block 106 is true and the logic of FIG. 4 ends.

If, however, the logic for the category specific browser should not exit (no in decision block 106), a test is made to determine if data should be retrieved from the server (decision block 107). If so, a database query is formatted (step 108). In this manner, the server is constantly polled for new data. In exemplary embodiments, the category specific browser transmits messages requesting data. The “query message” format is independent of the format of the query message used to query the database. The server formats an appropriate query (e.g., a Structured Query Language (SQL) query) and retrieves the desired information from the database. The server transmits the requested information received from the category specific database to the category specific browser on the user's computer 22. The category specific browser receives the data from the server (step 114). The data is parsed and formatted and then displayed in the category specific browser (step 116). The logic of obtaining and processing inputs (steps 104-116) is repeated until it is time to exit (yes in decision block 106). When it is time to exit, the logic of FIG. 4 ends.

FIGS. 5A-5J illustrate exemplary screen shots for a category specific mini browser formed in accordance with the present invention. The mini browser will only play/display specific information. For example, the category specific browser may be directed to electronic trading card data, such as is described in U.S. patent application Ser. No. 09/718,298, filed Nov. 21, 2000, the contents of that are incorporated herein by reference. The category specific browser shown in FIGS. 5A-5J illustrates an exemplary user interface for a category specific browser for electronic trading cards. The illustrated example is directed to football trading cards. Alternative category specific browsers may be directed to other sports, e.g., baseball, basketball, hockey, soccer, or some combination thereof. Other types of trading cards may also be the subject matter of a category specific browser, for example, business contacts, music personalities, television personalities, etc. A category specific browser may display information from several categories, for example, music personalities and sports personalities using different skins.

In the exemplary embodiment shown in FIGS. 5A-5J, the user interface window is irregular (i.e., nonrectangular) in shape. The user interface of the category specific mini browser of the present invention is a “skin” that can be customized. For example, one skin is used to display corporate category specific information and a different skin is used to display sports ETC category specific information. The different skins may include different graphics, different color schemes, different fonts, etc.

Controls, such as buttons, allow the user to interact with the category specific mini browser. The exemplary browser shown in FIGS. 5A-5J includes buttons around the perimeter of a circular window surrounding a display area 220. The home display is shown when the mini browser is initially displayed. In exemplary embodiments, such as the one shown in FIG. 5A, information is displayed in the viewing area 220 when the browser is in the home location. The example shown in FIG. 5A also includes a ticker window 222 that scrolls information so that new information is continually being displayed in the ticker window 222. The information in the ticker 222 is related to the currently active category of information being displayed in the category specific browser. In exemplary embodiments, if the user clicks on an item in the ticker window 222, the related story is displayed in the display area 220. Preferably, the display area 220 can be configured to display other information when in the home location, for example news or a list of available trading cards. A home button 200 allows the user to return to the home location at any time.

A shop button 202 allows the user to visit e-commerce sites related to the specific category of the display. For example, if the category specific browser is directed to sports electronic trading cards, the shopping function allows the user to easily access sites selling sports related goods.

A cards button 204 allows the user the capability to view ETCS. As shown in FIG. 5B, the browser can display a list of available ETCs so that the user can select a desired ETC to view. In exemplary embodiments, the list of cards displayed are cards that have been downloaded by the user. It will be appreciated that in alternative embodiments, the list of available cards may include cards stored on the server that have not been downloaded to the user's computer. In exemplary embodiments, the list provides an indication of whether the locally stored card is the most recent version of the card. For example, the cards in the card list may be color-coded to indicate whether the most recent information has been downloaded.

When the user selects a card, a subset of the electronic card is displayed. For example, as shown in FIG. 5C, a picture of the personality may be displayed. Additional information, such as statistics and/or videos may also be available. For example, as shown in FIG. 5D, the user may opt to view one or more videos related to the personality on the ETC.

In exemplary embodiments, selection of a games button 210 causes a display such as the one shown in FIG. 5E to be displayed. The user can play games related to the category of interest. The games may be found at various locations. For example, games could be stored on the server 20 or at an external website that is accessed over the Internet 36.

Users of a category specific browser form a community. By definition, members of the community share a common interest. The category specific browser of the present invention includes a chat feature that allows for communication among the members of the community that use the category specific browser. FIG. 5F illustrates an exemplary user interface for a mini browser chat function invoked by pressing a chat button 212.

Preferably, mini browsers formed in accordance with the present invention also include a news function in addition to category specific information. FIG. 5G illustrates an exemplary news display invoked by pressing a news button 214. The news function may be configured to only display news related to the category (e.g., sports news). Alternatively, the news feature may be configured to display a subset of news items commonly used by most users regardless of the category information, for example, headline news, local weather and stock information. The news function allows the user to view news without having to use a traditional browser in addition to the category specific browser. Thus, the category specific browser replaces the user's traditional browser.

In exemplary embodiments for ETCs, a trading button 216 allows a user to view ETCs available for trade. FIG. 5H illustrates an exemplary trade display that lists ETCs available for trading. In exemplary embodiments, a user can designate that any local ETCs (i.e., ETCs that have been downloaded to the user's computer) may be traded to one or more designated users. In exemplary embodiments, the ETC designated for trading is not downloaded to the server, rather the server stores an indication of the users that may request the ETC. Alternatively, the trade function may display ETCs available on the server or both ETCs available on the server and ETCs stored on another ETC user's computer that have been designated as available for trade to the ETC user 22.

In exemplary embodiments, a setup button 208 allows a user to configure a skin for a category specific browser. For example, pressing a setup button may cause a screen such as that shown in FIG. 5I to be displayed. Additional setup screens can be accessed via the setup display shown in FIG. 5I. For example, FIG. 5J illustrates an exemplary user interface screen that allows the user to change the skin (category specific information) being displayed.

Additional modifications and improvements of the present invention may also be apparent to those of ordinary skill in the art. Thus, the particular combination of parts described and illustrated herein is intended to represent only a certain embodiment of the present invention and is not intended to serve as a limitation of alternative devices within the spirit and scope of the invention.

1. A method for viewing and interacting with category specific data in a category specific browser, the method comprising:
a. generating a category specific browser user interface;
b. displaying the category specific browser user interface on a client computer;
c. establishing a dedicated connection between the client computer and a server computer, the server computer comprising a category specific database that stores the category specific data, the dedicated connection between the client computer and the server computer preventing the category specific browser from receiving data from any source other than the server, a plurality of client computers each having a respective dedicated connection to the server computer forming a targeted community wherein each client computer is a member of the targeted community and members of the targeted community all have access to the same category specific data;
d. in response to a user request at the client computer:
i. formatting a database query to retrieve selected category specific data from the category specific database;
ii. transmitting the database query to the server via the dedicated connection to the server;
iii. receiving the selected category specific data via the dedicated connection to the server; and
iv. displaying the selected category specific data in the category specific browser user interface.

2. The method of claim 1, wherein transmissions over the dedicated connection between the client computer and the server computer are encrypted.

3. The method of claim 1, further comprising:
a. in response to a user request, initiating a chat mode with one or more other members of the targeted community, the client computer and the one or more other members of the targeted community each simultaneously having a respective dedicated connection to the server, the chat mode excluding clients that do not have a dedicated connection to the server; and
b. while in the chat mode:
i. forwarding user input received via a user input device to the server for transmission to the one or more other members of the targeted community; and
ii. receiving data from one or more other members of the targeted community via the server and displaying the received data in the category specific browser user interface.

4. The method of claim 1,wherein the category specific database comprises data for a plurality of categories.

5. The method of claim 4, wherein the category specific browser can display data from multiple categories.

6. The method of claim 1, wherein the category specific data comprises electronic trading cards.

7. The method of claim 6, wherein the electronic trading cards relate to personalities.

8. The method of claim 7, wherein the personalities are sports personalities.

9. The method of claim 1, wherein the category specific data is corporate data comprising information about a specific business entity.

10. The method of claim 1, wherein the category specific data comprises video data.

11. The method of claim 1, wherein the category specific data comprises audio data.

12. The method of claim 1, wherein the generating the category specific browser user interface comprises:
a. providing a generic category specific browser user interface having a first appearance; and
b. in response to a user configuration command, modifying the generic category specific browser user interface to have a second appearance as defined by the user configuration command.

13. The method of claim 12, wherein the second appearance comprises a different logo than the first appearance.

14. The method of claim 12, wherein the second appearance comprises a different set of user controls than the first appearance.

15. The method of claim 1, further comprising displaying news in the category specific browser in addition to the category specific data.

16. A system for viewing and interacting with category specific data, the system comprising:
a. a category specific browser that displays category specific data; and
b. an external interface in communication with the category specific browser, the external interface forwarding data received from a server to the category specific browser and transmitting data received from the category specific browser to the server, the external interface establishing an exclusive connection to the server that prevents the category specific browser from receiving data from a source other than the server.

17. The system of claim 16, wherein the category specific data comprises electronic trading cards.
